(19) United States
(12) Patent Application Publication
(10) Pub. No.: US 2025/0077621 A1
(43) Pub. Date: Mar. 6, 2025

(54) LEARNING PROCESSING DEVICE AND LEARNING PROCESSING METHOD FOR POOLING HIERARCHICALLY STRUCTURED GRAPH DATA ON BASIS OF GROUPING MATRIX, AND METHOD FOR TRAINING ARTIFICIAL INTELLIGENCE MODEL

(71) Applicant: LG MANAGEMENT DEVELOPMENT INSTITUTE CO., LTD., Seoul (KR)

(72) Inventors: Sung Moon KO, Gimpo-si (KR); Sungjun CHO, Seoul (KR); Daewoong JEONG, Seoul (KR); Sehui HAN, Seoul (KR); Moontae LEE, Seoul (KR); Honglak LEE, Seoul (KR)

(21) Appl. No.: 18/950,349

(22) Filed: Nov. 18, 2024

Related U.S. Application Data
(63) Continuation of application No. PCT/KR2023/006356, filed on May 10, 2023.

(30) Foreign Application Priority Data
May 17, 2022 (KR) 10-2022-0059976
Nov. 17, 2022 (KR) 10-2022-0154579

(51) Int. Cl. G06F 18/2323

(52) U.S. Cl. CPC G06F 18/2323

(57) ABSTRACT

A learning processing device and method for pooling graph data of a hierarchical structure based on a grouping matrix, and a method for learning an artificial intelligence model. The learning processing device includes a memory and a processor in communication with the memory. The processor generates a grouping matrix of a secondary form, grouped based on a similarity of a pairwise nodes by inputting graph data into a pre-learned first artificial intelligence model; and decomposes the grouping matrix to generate a pooling matrix. The grouping matrix is decomposed in a square-root form to obtain a pooling operator.

### CROSS REFERENCE TO RELATED APPLICATIONS

This application is a Bypass Continuation of International Patent Application No. PCT/KR2023/006356, filed on May 10, 2023, which claims priority from and the benefit of Korean Patent Application No. 10-2022-0059976, filed on May 17, 2022, and Korean Patent Application No 10-2022-0154579, filed on Nov. 17, 2022, each of which is hereby incorporated by reference for all purposes as if fully set forth herein.

### BACKGROUND

### Field

Embodiments of the invention relate generally to a method for pooling graph data, and more specifically, to a learning processing device, a learning processing method, and a method for learning an artificial intelligence model for pooling graph data of a hierarchical structure based on a grouping matrix.

### Discussion of the Background

Graph neural networks (GNN) are capable of learning representations of individual nodes based on the connective structure of the input graph.

In the case of graph-level prediction tasks, the standard procedure may involve globally pooling all node features into a single graph representation without weighing differences, and then providing that representation to the final prediction layer. This procedure may make it difficult for the model to hierarchically aggregate information beyond local convolutions, as information is only propagated through edges between nodes.

The above information disclosed in this Background section is only for understanding of the background of the inventive concepts, and, therefore, it may contain information that does not constitute prior art.

### SUMMARY

A learning processing device, a learning processing method, and a method for learning an artificial intelligence model according to embodiments of the invention are capable of pooling graph data of a hierarchical structure based on a grouping matrix that automatically determines the number of clusters in the graph data.

Additional features of the inventive concepts will be set forth in the description which follows, and in part will be apparent from the description, or may be learned by practice of the inventive concepts.

An embodiment of the invention provides a learning processing device including a memory and a processor in communication with the memory. The processor generates a grouping matrix of a secondary form grouped based on a similarity of pairwise nodes by inputting graph data into a pre-learned artificial intelligence model, and decomposes the grouping matrix to generate a pooling matrix, wherein the grouping matrix is decomposed in a square-root form to obtain a pooling operator.

Another embodiment of the invention provides a learning processing method including: generating a grouping matrix in a secondary form, grouped based on a similarity of pairwise nodes by inputting graph data into a pre-learned first artificial intelligence model; and decomposing the grouping matrix to generate a pooling matrix, wherein the grouping matrix is decomposed in a square-root form to obtain a pooling operator.

Another embodiment of the invention provides a method for learning an artificial intelligence model including collecting graph data and learning an artificial intelligence model using the collected graph data. The learning the artificial intelligence model includes: generating a grouping matrix in a secondary form, grouped based on similarity of pairwise nodes using the collected graph data; and decomposing the grouping matrix to generate and output a pooling matrix, wherein the grouping matrix is decomposed in a square-root form to obtain a pooling operator.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of a learning processing device of an embodiment of the inventive concepts.

FIG. 2 is a block diagram for explaining in detail some of the configurations of FIG. 1.

FIG. 3 is a diagram showing the framework of an embodiment of the inventive concepts.

FIG. 4 is an exemplary diagram for explaining the learning processing method of an embodiment of the inventive concepts.

FIG. 5 is a flowchart for explaining the learning processing method of an embodiment of the inventive concepts.

FIG. 6 is a flowchart for explaining the method for learning an artificial intelligence model of an embodiment of the inventive concepts.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

In this specification, the “learning processing device” according to embodiments of the invention includes all of various devices capable of performing computational processing and providing results to users. For example, the learning processing device according to the invention may include all of a computer, a server device, and a portable terminal, or may be in any one form.

Here, the computer may include, for example, a notebook, desktop, laptop, tablet PC, slate PC, etc. equipped with a WEB Browser.

The server device is a server that processes information by communicating with an external device, and may include an application server, a computing server, a database server, a file server, a game server, a mail server, a proxy server, and a web server, etc.

The portable terminal is, for example, a wireless communication device that ensures portability and mobility, and includes all types of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, WCDMA (W-Code Division Multiple Access), WiBro (Wireless Broadband Internet) terminals, smart phones, and wearable devices such as a watch, ring, bracelet, anklet, necklace, glasses, contact lenses, and a head-mounted-device (HMD).

The “graph pooling” of embodiments of the invention may mean generating a graph that is more simply diagrammed than before by grouping the full graph based on similarity according to downstream tasks. This graph pooling may be an important task in encoding the hierarchical structure within a graph.

A general graph pooling approach may be handled as a node clustering task that effectively captures the graph topology. This general method allows the user to pre-specify an appropriate number of clusters as a hyperparameter, and then ensure that all input graphs share the same number of clusters.

In an inductive setting where the number of clusters may vary, the artificial intelligence model should be able to apply varying numbers of clusters to the pooling layer to learn suitable clusters.

Accordingly, embodiments of the invention may provide a differentiable graph pooling architecture (e.g., GMPool) that automatically determines the appropriate number of clusters based on graph data as input data.

A hierarchical structure may encode the global topology of the graph, which is useful for effective learning of long-range interactions. Therefore, designing a pooling architecture that takes into account the graph structure may be important for downstream tasks such as social network analysis and molecular property prediction.

As an alternative to the above-described global pooling, DiffPool may perform end-to-end differentiable pooling by first soft classifying each node into a smaller number of clusters. Subsequently, gPool and SAGpool integrate the attention mechanism into pooling, while MinCutPool may group nodes into clusters by minimizing the relaxed K-way regularized minimum cut objective.

In most general inductive settings, there is no single number of clusters that fits all graphs in the dataset. In particular, in molecular graphs, the number of functional groups may significantly vary between molecules, while determining useful characteristics and chemical behavior. General pooling methods require the number of clusters as a hyperparameter and operate under the assumption that all graphs share the same number of clusters. This not only requires additional hyperparameter tuning, but may also impose a strong inductive bias that degrades downstream performance.

Accordingly, the inventive concepts provide a pooling framework that may automatically determine the number of clusters without requiring a universal number of clusters as a user hyperparameter in advance, which will be described in detail later.

It may be assumed that all representation spaces described later in embodiments are based on Euclidean space.

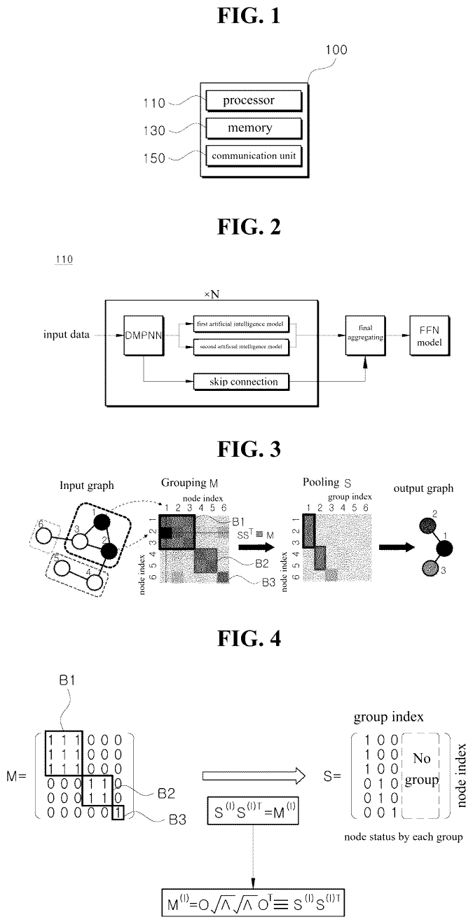

FIG. 1 is a block diagram of the learning processing device of an embodiment of the invention, and FIG. 2 is a block diagram for explaining in detail some of the configurations of FIG. 1.

Hereinafter, the description will be made with reference to FIG. 3, which shows the framework of an embodiment of the invention, and FIG. 4, which is an example diagram for explaining the learning processing method of the inventive concepts.

Referring to FIG. 1, the learning processing device 100 includes a processor 110, a memory 130, and a communication unit 150. In this case, the processor 110 may include a plurality of artificial intelligence models for learning processing and may control the operation of each of the memory 130 and the communication unit 150. The components shown in FIG. 1 are not essential for implementing the learning processing device 100 according to the inventive concepts, so the learning processing device 100 described in this specification may have more or fewer components than the components listed above.

Referring to FIG. 1, the processor 110 may generate a grouping matrix in a secondary form, grouped based on similarity of a pairwise node by inputting graph data into a pre-learned first artificial intelligence model. In this case, the grouping criteria may be determined according to the downstream task.

For example, the graph data may be in the form of SMILES (simplified molecular-input line-entry system), but is not limited thereto.

The first artificial intelligence model may be a model learned to group based on correlations between the nodes.

Specifically, the processor 110 may generate a grouping matrix defined as a secondary format of pooling operators that induce the use of binary classification probabilities for pairwise combinations of nodes in the input graph data.

Referring to FIG. 4, the processor 110, when generating the grouping matrix, may group (B1, B2, B3) a plurality of nodes in the graph data and a connection relationship between the plurality of nodes by designating them as identifiers of 0 or more to 1 or less based on similarity according to a preset grouping criterion. In other words, the processor 110 may group a plurality of nodes in the graph data and a connection relationship between the plurality of nodes by designating them as identifiers of any one of 0, 1, and 0 to 1 (0˜1).

In this case, 0 may mean different groups, 1 may mean the same group, and 0 to 1 ([0, 1]) may mean different values depending on the degree to which they are judged as the same group.

FIG. 3 is a diagram showing the framework of an embodiment of the invention, with showing the entire framework of GMPool as an example.

Referring to FIG. 3, when the processor 110 receives graph data (input graph), which is input data, it may form a grouping matrix (Grouping M) that encodes the clustering similarity between each pair of nodes (1˜6) of the graph data.

In this case, the grouping matrix may include the group block B1, which contains nodes 1, 2, and 3; the group block B2, which contains nodes 4 and 5; and the group block B3, which contains node 6.

The input data may include all of graph data with a hierarchical structure. This graph data with a hierarchical structure may include a plurality of nodes and edges, which represent a connection relationship between the nodes. For example, the graph data may represent molecular formulas or social network data, etc.

In FIG. 3, the product of the pooling matrices may form the grouping matrix by itself. In this case, each (i, j)th item may indicate pairwise clustering similarity, such as whether node i and node j are pooled into the same cluster.

The processor 110 may parameterize the clustering similarity of the grouping matrix through a classification layer for each graph data.

The processor 110 may assume an inductive graph-level prediction setting, in which the goal is to learn a function f_{θ}: g→Y that maps a graph G∈g to an attribute label y∈Y.

Each graph data that includes a plurality of nodes may be formed as a triplet that includes graph adjacency, node features, and edge features. Based on this, the processor 110 may consider graph adjacency, node features, and edge features when determining the similarity of the pairwise nodes in the graph data.

For example, graph data G with n nodes may be represented as a triplet G=(A, X, E) with graph adjacency A∈{0, 1}ⁿ⁻ⁿ, node features X∈R^{n-dn}, and edge features E∈R^{n-n-de} .

According to embodiments, Xᵢ and Eᵢⱼ may be used to represent the functions of node i and edge (i, j), respectively.

The above-described grouping matrix may be based on a binary classification system of pairwise node combinations. Accordingly, before generating the grouping matrix, the processor 110 may obtain node representations using a GNN model. In this case, the DMPNN (Directed Message Passing Neural Network) may be applied as the encoder.

The processor 110 may extract node features from the graph data which is input data.

In this case, referring to FIG. 2, the processor 110 may apply DMPNN, which aggregates messages through directed edge, as the backbone GNN, but is not limited thereto.

Specifically, referring to FIG. 2, when the processor 110 receives graph data as input data, it may initialize the hidden state of each edge (i, j) based on the first feature (Eᵢⱼ), which is the edge feature, and the second feature (Xᵢ), which is the feature of the source node.

The processor 110 may collect the hidden states from incident edges in each direction edge to message mᵢⱼ^{t+1} at each time step t, and update the hidden states to hᵢⱼ^{t+1} as in Equations 1 and 2. In this case, incident edges may mean a relationship between a node and edges connected to the node.

$${m}_{ij}^{t + 1} = {\sum }_{k ∈ N ( i ) ∖ j} {h}_{ki}^{t} \qquad [ Equation 1 ]$$

$${h}_{ij}^{t + 1} = ReLU ( {h}_{ij}^{0} + {W}_{e} {m}_{ij}^{t + 1} ) , \qquad [ Equation 2 ]$$

wherein, N(i) is the set of adjacency nodes of node i, and Wₑ may be a learnable weight.

Referring to Equations 3 and 4 described later, the hidden state of the node may be updated through the nonlinearity of the ReLU (rectified linear unit) function after aggregating the hidden state of the incident edges into the message mᵢ^{t+1} and passing the connection with the node feature Xᵢ to the linear layer. In this case, the ReLU function outputs 0 if the input value is less than 0, and outputs the input value as-is if the input value is greater than 0.

$${m}_{i}^{t + 1} = {\sum }_{j ∈ N ( i )} {h}_{ij}^{t} \qquad [ Equation 3 ]$$

$${h}_{i}^{t + 1} = ReLU ( {W}_{n} concat ( {X}_{i} , {m}_{i}^{t + 1} ) ) \qquad [ Equation 4 ]$$

Wₙ may be a learnable weight. Assuming that the DMPNN runs for T time steps, the processor 110 may represent the output representation matrix containing the hidden states of each and every node and edge using (Xₒᵤₜ, Eₒᵤₜ)=GNN(A, X, E), as follows.

$${X}_{out , i} = {h}_{i}^{T} ,$$

$${E}_{out , ij} = {h}_{ij}^{T}$$

The processor 110 may learn a pooling operator that coarsens graph data, which is input data after the GNN, in each hierarchical layer.

At each hierarchical layer, the processor 110 may construct node representations through the GNN and form a coarsened graph, which is used as input for the next hierarchical layer through the pooling layer.

In this case, coarsening graph data may mean grouping similar nodes into a single cluster and using them as nodes again to form a graph with a reduced number of nodes.

Specifically, if the 1st layer is (Xₒᵤₜ^{(l)}, Eₒᵤₜ^{(l)})=GNN(A^{(l)}, X^{(l)}, E⁽¹⁾, the pooling layer may generate an assignment matrix S^{(l)}∈Rⁿ^{ₗ}^{×n}^{ₗ₊₁} that pools n₁ nodes into nₗ₊₁ clusters. Then, the graph G^{(l)}=(A^{(l)}, X^{(l)}, E^{(l)}) may be coarsened to G^{(l+1)}−(A^{(l+1)}, X^{(l+1)}, E^{(l+1)})−(S^{(l)}^{^{T}}A^{(l)}S^{(l)}, S^{(l)}^{^{T}}Xₒᵤₜ^{(l)}, S^{(l)}^{^{T}}Eₒᵤₜ^{(l)}S^{(l)}). This hierarchical process may be repeatedly utilized according to that task.

Hereinafter, the grouping operation based on the relationship between node pairs will be described.

The processor 110 may form a grouping matrix that contains the clustering similarity between pairwise nodes.

The processor 110 may perform the task of classifying whether each node pair belongs to the same group. In this case, the group may also be named a cluster.

According to embodiments, the processor 110 may omit the procedure of presetting the number of clusters.

The above-described classification may go through all node combination pairs to ensure permutation invariance.

$${M}_{ij}^{( l )} = Soft max ( Clf ( f ( {X}_{i} , {X}_{j} ) ) ) ∀ i , j ∈ \# of Nodes \qquad [ Equation 5 ]$$

Here, M^{(l)}∈R^{N-N} may be possible, and f may be a commutative function.

$$f : X ⊕ X \to Y \qquad [ Equation 6 ]$$

Here, X, Y∈R^{N} may be possible.

The processor 110 may map two input vectors into one output vector.

While there are multiple options available for f, to simplify the classification task, Euclidean distance between input vectors may be used. Each matrix index corresponds to a node number, and each element may include probability values for each pair of nodes, regardless of whether the pair of nodes belongs to the same group.

As an example, the processor 110 may consider a set of distinct clusters with no overlapping nodes.

In this case, referring to FIG. 4, the grouping matrix M may be reconstructed into a block diagonal form including 0 and 1 as elements. The number of blocks (B1, B2, B3) corresponds to the number of groups after pooling, and nodes assigned to the same block may correspond to the same group.

For example, if there are three different groups, and each group has sizes k1, k2, k3, it may be as shown in Equation 7.

$${M}^{( l )} = [ \begin{matrix}\begin{matrix}{1}_{{k}_{1} \times {k}_{1}}\end{matrix} & 0 & 0 \\ 0 & \begin{matrix}{1}_{{k}_{2} \times {k}_{2}}\end{matrix} & 0 \\ 0 & 0 & \begin{matrix}{1}_{{k}_{3} \times {k}_{3}}\end{matrix}\end{matrix} ] \qquad [ Equation 7 ]$$

Each element of the grouping matrix in Equation 7 may be a “soft-clustering” in which nodes overlap, with consecutive numbers between [0, 1].

The grouping matrix may be based on a binary classification system for pairwise node combinations. Accordingly, one may start by obtaining node representations with a GNN model. The inventive concepts may apply DMPNN as an encoder.

The processor 110 may preferentially calculate a tensor of rank 2 of pairwise node combinations of input graph data to form a grouping matrix. The rank 2 tensor may mean nine components (nodes) representing a size and two directions.

In this case, the order of the nodes is irrelevant, so the tensor must be symmetric, and the exchange function may be used in the procedure. The inventive concepts may focus on the Euclidean distance between pairs of nodes to simplify classification.

$${X}_{( μν )}^{h i} = \vert {Γ}_{μν}^{p} {F}_{( n ode )} {γ}^{hi} - {( {Γ}_{μν}^{p} {F}_{( node )} {γ}^{hi} )}^{T} \vert \qquad [ Equation 8 ]$$

The X_{(μv)}^{hi} may be the graph data as input data, F_{(node)}γ^{hi} may be the node features. Γ_{μv}^{P} may be defined as a generalized adjacency tensor as shown in Equation 9. μ, v may mean the tensor component indices, and hᵢ may mean indices for hidden dimensions.

$${Γ}_{μν}^{p} = \{ \begin{matrix}1 & if ν = p \\ 0 & otherwise\end{matrix} \qquad [ Equation 9 ]$$

The binary classifier according to embodiments may be set to be simple in order to avoid overfitting issues. In addition, embodiments may use a single layer with softmax activation to extract probabilities for each pair of nodes.

$${M}_{( μν )} = f ( {W}_{{h}_{i}} {X}_{μν}^{{h}_{i}} ) \qquad [ Equation 10 ]$$

The M_{(μv)} may be the grouping matrix, and Wₕ_{ᵢ} may be the weight of the layer.

Since the input data, graph data, is symmetric under the index, the grouping matrix may also be symmetric. All steps of the computation are node-level based, and if the activation function f is an element-wise operation, Equations 8 and 9 may be permutation equivariant using the permutation operator P_{μ}^{v}.

In the case of ideal groupings, where no pair of nodes is simultaneously assigned to multiple groups, the grouping matrix may only contain 0, 1 for elements.

By using an appropriate permutation, node pairs in the same group may be collected within adjacent ranges, and the grouping matrix may be formed in a block diagonal.

In a block diagonal matrix, the number of blocks may correspond to the number of groups after pooling, and same group during pooling may include pairs of nodes assigned to it. For example, if there are three different groups with sizes k1, k2, k3, the grouping matrix may be as shown in Equation 11.

$${M}_{μν} = [ \begin{matrix}\begin{matrix}{1}_{{k}_{1} \times {k}_{1}}\end{matrix} & 0 & 0 \\ 0 & \begin{matrix}{1}_{{k}_{2} \times {k}_{2}}\end{matrix} & 0 \\ 0 & 0 & \begin{matrix}{1}_{{k}_{3} \times {k}_{3}}\end{matrix}\end{matrix} ] \qquad [ Equation 11 ]$$

The processor 110 may decompose the grouping matrix to generate a pooling matrix, in which the grouping matrix is decomposed in a square-root form to obtain a pooling operator. In other words, the processor 110 decomposes the grouping matrix to obtain a pooling matrix in a coarsened form of the graph.

The above-described processor 110 may generate the above-described pooling matrix through a second artificial intelligence model. In this time, the second artificial intelligence model may be a pre-learned model to generate a pooling matrix based on the grouping matrix.

Referring to FIGS. 3 and 4, the pooling matrix (pooling S) may be obtained based on the fact that the product of the pooling operator(S) and the transpose of the pooling operator (ST) is equal to the grouping matrix (M) (SS^{T}=M).

The processor 110 may generate the pooling operator, including the number of groups after pooling and the nodes assigned within the same group.

Referring to FIG. 3, it may be confirmed that the number of groups in the pooling matrix is three, with the first group (group index 1) including nodes 1, 2, and 3, the second group (group index 2) including nodes 4 and 5, and the third group (group index 3) including node 6. This pooling matrix may then be output in the form of an output graph.

Referring to FIG. 4, the pooling matrix may be represented with identifiers between 0 or more and 1 or less, indicating the node distribution by each group.

The above-described grouping matrix itself may play a limited role in the pooling operation. Accordingly, the processor 110 may generate a pooling operator based on the grouping matrix.

The processor 110 may decompose the grouping matrix into its square-root form as shown in Equation 12 to obtain the pooling operator.

The pooling operator may be as shown in Equation 12. Every single element may be generalized to a continuous number in the range [0, 1] for the grouping matrix of Equation 7, which represents the soft clustering case.

$${S}^{( l )} = [ \begin{matrix}\begin{matrix}{1}_{{k}_{1} \times 1}\end{matrix} & 0 & 0 & … & 0 \\ 0 & \begin{matrix}{1}_{{k}_{2} \times 1}\end{matrix} & 0 & … & 0 \\ 0 & 0 & \begin{matrix}{1}_{{k}_{3} \times 1}\end{matrix} & … & 0\end{matrix} ] \qquad [ Equation 12 ]$$

The processor 110 may generate the pooling operator based on Equations 13 and 16, which will be described later. The pooling operator may be in the form of a transformation matrix that includes the node status for each group.

Specifically, the grouping matrix may not be used for pooling as it is, but since it is equal to the product of the pooling operator and the transpose, as in Equation 13, it may be encoded in a similar way to how each node pair is pooled.

The (i, j)th item of the grouping matrix is equal to <Sᵢ^{(l)}, Sⱼ^{(l)}>=1 when nodes are exactly pooled into the same cluster and equal to <Sᵢ^{(l)}, Sⱼ^{(l)}>=0 when pooled orthogonally into different clusters. Therefore, by decomposing the grouping matrix into a square-root form, it may be interpreted as a pooling operator for the model.

$${S}^{( l )} {S}^{( l ) T} = {M}^{( l )} \qquad [ Equation 13 ]$$

The S^{(l)} is the pooling operator for the l-th layer, and the pooling operator S∈Rⁿ^{ₗ}^{×n}^{ₗ₊₁} is a matrix in nₗ₊₁≤nₗ. By multiplying the pooling operator S in reverse order, a degree matrix D∈Rⁿ^{ₗ₊₁}^{×n}^{ₗ₊₁} of the pooling space, as shown in Equation 14, may be obtained.

$${S}^{( l ) T} {S}^{( l )} = {D}^{( l )} \qquad [ Equation 14 ]$$

Referring to Equation 13, the pooling operator interacts with the pooling indices to fully reconstruct the grouping matrix. In addition, the pooling operator S may be interpreted as a weighted matrix for each node to form an appropriate substructure.

As an example, the processor 110 may use eigen decomposition as shown in Equation 15 to perform decomposition. The eigen decomposition may be applied to decompose a given matrix into its orthonormal basis O∈Rⁿ^{₁}^{×n}^{ₗ} and eigen values A∈Rⁿ^{ₗ}^{×n}^{ₗ}.

$${M}^{( l )} = O Λ {O}^{T} \qquad [ Equation 15 ]$$

The above-described eigen decomposition way may always be applied as long as the determinant of the given matrix is non-zero.

In Equation 15, when set to nₗ₊₁=nₗ, the right-hand side (RHS) of the equation may be rearranged into a square-form pooling operator, obtained in Equation 16.

$${M}^{( l )} = O \sqrt{Λ} \sqrt{Λ} {O}^{T} ≡ {S}^{( l )} {S}^{( l ) T} \qquad [ Equation 16 ]$$

The M^{(l)} may be the grouping matrix at the 1st layer, the O may be O∈Rⁿ^{ₗ}^{×n}^{ₗ} in the orthonormal basis of the given matrix, and the Λ may be A∈Rⁿ^{ₗ}^{×n}^{ₗ} as the eigen values.

The pooling operator S is a square matrix of size nₗ×nₗ, but the eigen values Λ may limit unnecessary ranks in the matrix by multiplying each column of the orthonormal basis by 0. Since this eigen decomposition may be applied to all matrices with a non-zero determinant, such may have the effect of being perfectly performed in real situations.

In addition, all symmetric and real matrices may be guaranteed to have real eigen values, just like vectors. Accordingly, the square-root of the grouping matrix may be interpreted as a conversion operator that forms subgroups from the nodes.

The above-described continuous real-valued elements allow nodes to be soft-clustered into subgroups. In general clustering, it may be difficult to appropriately cluster above-described structures. The soft clustering according to embodiments is naturally incorporated into the algorithm, making it easier to handle linker structures.

While the nodes may be in the fundamental representation, edge features and the adjacency matrix may be in the adjoint representation. This may be expressed by the conversion rules in Equations 17 through 19.

$${X}_{i}^{( l + 1 )} = {S}^{( l )} {X}_{i}^{( l )} . \qquad [ Equation 17 ]$$

$${E}_{i j}^{( l + 1 )} = {S}^{( l )} {E}_{i j}^{( l )} {S}^{( l ) T} \qquad [ Equation 18 ]$$

$${A}_{i j}^{( l + 1 )} = {S}^{( l )} {A}_{i j}^{( l )} {S}^{( l ) T} \qquad [ Equation 19 ]$$

If the grouping is done correctly, an eigen value matrix may be generated in which zero (or close to zero) components are decomposed.

As another example, the processor 110 may perform Singular Value Decomposition (SVD) on the grouping matrix to obtain a pooling matrix so that the overall rank represents an appropriate number of clusters.

For example, when the vectors in matrices U and V are called singular vectors, all singular vectors may have the property of being orthogonal to each other. Sigma Σ is a diagonal matrix, and only the values located on the main diagonal of the matrix may be non-zero, and the values of all remaining positions may be zero.

As another example, referring back to FIG. 2, the processor 110 may perform pooling without decomposing the grouping matrix (skip connection). In other words, the processor 110 may apply a single pooling variant (NGMPool) that uses the grouping matrix as it is, without performing decomposition.

The processor 110 may provide an effect such as pooling by multiplying grouping matrices without decomposing the grouping matrix based on the fact that the squares of the grouping matrix and the pooling operator are the same.

Specifically, the processor 110 may maintain a pooling depth of 1 and apply a weighted aggregation vector in the pooling space, based on aggregated weights.

The weighted aggregation vector may be converted into a Euclidean one-vector by applying the pooling matrix obtained through the decomposition of the grouping matrix, as shown in Equation 20.

$${1}_{i}^{( l + 1 )} = {S}^{( l )} {1}_{i}^{( l )} \qquad [ Equation 20 ]$$

The final form of the transformation may be as shown in Equations 21 and 22.

$${X}_{i}^{( l + 1 )} ∼ {M}^{( l )} {X}_{i}^{( l )} \qquad [ Equation 21 ]$$

$${E}_{i j}^{( l + 1 )} ∼ {M}^{( l )} {E}_{i j}^{( l )} {M}^{( l )} \qquad [ Equation 22 ]$$

Referring to FIG. 2, the processor 110 may finally combine the grouping matrix, formed based on the graph data through the first artificial intelligence model, and the pooling matrix, formed either through the second artificial intelligence model or the skip connection process, and apply them to the Feed-Forward Network (FFN) model.

Through this, the processor 110 may obtain an output graph (output graph in FIG. 3) where one group operates as one node. The above-described pooling matrix may be obtained either by decomposing or without decomposing the grouping matrix.

For example, when the input graph data is a Thermally Activated Delayed

Fluorescence (TADF) molecule that includes both donor and acceptor, with a hierarchical structure, the learning process of the inventive concepts, which may automatically determine the number of clusters, may improve the accuracy of molecular property predictions. In this case, the graph data may be input in the form of simplified molecular-input line-entry system (SMILES).

Specifically, TADF molecules may have different numbers of structures depending on the size of the molecule, and since embodiments of the invention may automatically determine the number of clusters without presetting the number of clusters (groups), it is possible to distinguish each molecule into a different number of groups.

The processor 110 of the learning processing device 100, when graph data is input, may generate a secondary form of grouping matrix by setting the input graph data as a dataset, learn an artificial intelligence model to decompose the grouping matrix, and generate and output a pooling matrix. In this case, the artificial intelligence model may mean an artificial intelligence model implemented in the inventive concepts, including the above-described first and second artificial intelligence models.

Specifically, the processor 110 may collect graph data. In this case, the graph may be plural.

The processor 110 may learn an artificial intelligence model using the collected graph data.

More specifically, the processor 110 may generate a grouping matrix in a secondary form, grouped based on similarity of a pairwise node using the collected graph data. In addition, the processor 110 may decompose the grouping matrix to generate and output a pooling matrix, wherein the grouping matrix is decomposed in the square-root form to obtain a pooling operator.

The memory 130 may store a computer program for providing the learning processing method of the inventive concepts, and the stored computer program may be read and driven by the processor 110. The memory 130 may store any form of information generated or determined by the processor 110 and any form of information received by the communication unit 150.

The memory 130 may store data supporting various functions of the learning processing device 100, and programs for the operation of the processor 110, input/output data, multiple application programs or application executed by the learning processing device 100, data for the operation of the learning processing device 100, and commands. At least some of these application programs may be downloaded from external servers through wireless communication.

This memory 130 may include at least one type of storage medium among flash memory type, hard disk type, solid state disk type (SSD type), silicon disk drive type (SDD type), multimedia card micro type, card-type memory (e.g., SD, XD memory, or etc.), RAM (Random Access Memory), static random access memory (SRAM), ROM (Read-only memory), electrically erasable programmable read-only memory (EEPROM), programmable read-only memory (PROM), magnetic memory, magnetic disk, and optical disk. In addition, the memory may be a database that is separate from the device, but is connected wired or wireless.

The communication unit 150 may include one or more components enabling communication with external devices, and, for example, may include at least of a broadcast reception module, wired communication module, wireless communication module, near-field communication module, or location information module.

Although not shown, the learning processing device 100 of the inventive concepts may further include an output unit and an input unit.

The output unit may display a user interface (UI) to provide the results of learning processing and the likes, including graph pooling data. The output unit may output any form of information generated or determined by the processor 110 and any form of information received by the communication unit 150.

The output unit may include at least one of a liquid crystal display (LCD), thin film transistor-liquid crystal display (TFT LCD), organic light-emitting diode (OLED), flexible display, or 3D display. Some of these display modules may be configured as transparent or light-transmitting so that the exterior may be viewed through them. These are referred to as transparent display modules, with a representative example of the transparent display modules being a Transparent OLED (TOLED) and the like.

The input unit may receive information input by the user. The input unit may include keys and/or buttons on a user interface for receiving information inputted by the user, or physical keys and/or buttons. A computer program for controlling the display according to embodiments of the invention may be executed based on user input through the input unit.

Graph pooling generally allows the number of clusters to be predefined as a hyperparameter for each layer. This may be inconsistent in inductive settings such as molecular property prediction, where each graph may have a varying number of useful substructures.

Since the invention pools the model into a varying number of clusters based on the graph data, the learning performance for graph data with hierarchical structures, including molecular property prediction, may be improved. GMPool of the inventive concepts may allow for the variability of above-described cluster number through the rank of the grouping matrix. In other words, the inventive concepts may omit the process of manually adjusting the number of clusters through additional hyperparameter tuning.

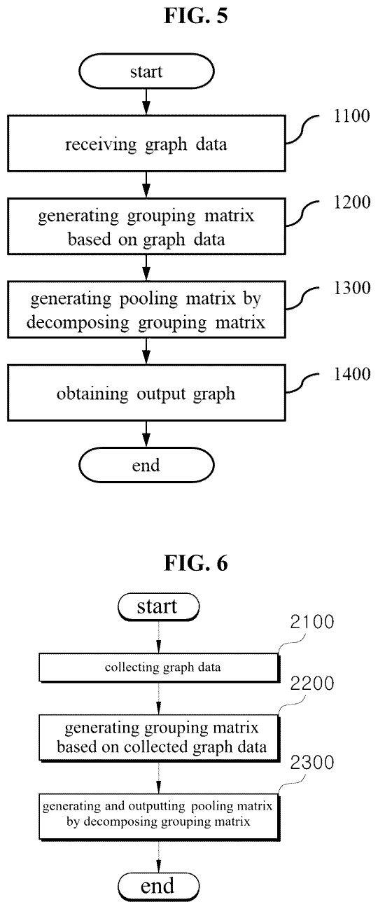

FIG. 5 is a flowchart for explaining the learning processing method of the inventive concepts.

Referring to FIG. 5, the processor 110 of the learning processing device 100 may receive graph data at Step 1100.

Then, the processor 110 may generate a grouping matrix in a secondary form, grouped based on similarity of a pairwise node by inputting graph data into a pre-learned first artificial intelligence model at Step 1200.

The processor 110 may group a plurality of nodes in the graph data and a connection relationship between the plurality of nodes by designating them as identifiers of 0 or more to 1 or less based on similarity according to a preset grouping criterion. In other words, the processor 110 may group a plurality of nodes in the graph data and a connection relationship between the plurality of nodes by designating them as identifiers of any one of 0, 1, and 0 to 1 (0˜1).

In this case, 0 may mean different groups, 1 may mean the same group, and 0 to 1 ([0, 1]) may mean different values depending on the degree to which they are judged as the same group.

Then, the processor 110 decomposes the grouping matrix to generate a pooling matrix, in which the grouping matrix is decomposed in the square-root form to obtain a pooling operator at Step 1300. The pooling operator may take the form of a transformation matrix that includes the node states of each group.

The processor 110 generates the pooling operator, including the number of groups after pooling and the nodes assigned to the same group.

The processor 110 may generate the pooling operator based on Equations 13 and 16.

Then, the processor 110 may obtain the output graph at Step 1400.

The output graph allows one group to act as one node.

FIG. 6 is a flowchart for explaining the method for learning an artificial

intelligence model of the inventive concepts, and will be described as an example of a method of learning the above-described artificial intelligence model mentioned in FIGS. 1 and 5. Hereinafter, the above-described first and second artificial intelligence models will both be referred to as the “artificial intelligence model”.

First, the processor 110 of the learning processing device 100 may collect graph data at Step 2100. In this case, the graph data may be plural.

Then, the processor 110 may learn the artificial intelligence model using the collected graph data at Steps 2200-2300.

Specifically, the processor 110 may generate a grouping matrix of a secondary form, which is grouped based on similarity of a pairwise node using the collected graph data at Step 2200.

Then, the processor 110 may decompose the grouping matrix to generate and output a pooling matrix, in which the grouping matrix is decomposed in a square-root form to obtain a pooling operator at Step 2300.

That is, the artificial intelligence model of the inventive concepts may be learned such that, when graph data is input, it is set as a dataset to generate a secondary form of grouping matrix, and the grouping matrix is decomposed to generate and output the pooling matrix.

Although it is not disclosed in FIG. 6 for convenience of explanation, it is natural that the artificial intelligence model is learned to additionally perform the roles of the first and second artificial intelligence models of FIGS. 1 and 5.

The above-described inventive concepts may be applied to all graph data with hierarchical structures, including social data, authorship data, and molecular.

The aforementioned method according to the inventive concepts may be implemented as a program (or application) to be executed in combination with a hardware server and stored in a medium.

The embodiments discussed herein may be implemented in the form of a recording medium storing executable commands by a computer. The commands may be stored in the form of program code, and when executed by a processor, a program module may be generated to perform the operations of the disclosed embodiments. The recording medium may be implemented as a computer-readable recording medium.

The computer-readable recording medium includes all types of recording media in which instructions that may be interpreted by a computer are stored. For example, ROM (Read Only Memory), RAM (Random Access Memory), magnetic tapes, magnetic disks, flash memory, optical data storage devices and the like may be included.

According to the aforementioned embodiments, the inventive concepts provide a pooling framework that automatically determines the number of clusters without requiring a universal number of clusters as a user hyperparameter in advance.

According to the aforementioned embodiments, the inventive concepts make it possible to obtain an output graph that reflects the hierarchical structure of the input graph, regardless of the numbering order of the input data.

According to the aforementioned embodiments, even in cases where there is an association between a plurality of groups and the boundaries between groups are unclear, the inventive concepts make it possible to automatically distinguish the number of groups, thereby enabling accurate representation of the graph.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A learning processing device comprising:
a memory;
a processor in communication with the memory,
wherein the processor is configured to:
generate a grouping matrix of a secondary form, grouped based on a similarity of pairwise nodes by inputting graph data into a pre-learned artificial intelligence model; and
decompose the grouping matrix to generate a pooling matrix, wherein the grouping matrix is decomposed in a square-root form to obtain a pooling operator.

2. The learning processing device of claim 1, wherein the processor, when generating the grouping matrix, is configured to group a plurality of nodes in the graph data and a connection relationship between the plurality of nodes by designating the plurality of nodes and the connection relationship as identifiers of 0 or more to 1 or less based on similarity according to a preset grouping criterion.

3. The learning processing device of claim 2, wherein the processor is configured to generate the pooling operator comprising a number of groups after pooling and the nodes assigned within the same group.

4. The learning processing device of claim 1, wherein the processor is configured to generate the pooling operator based on equations (1) and (2) below:
S^{(l)}S^{(l)T}=M^{(l)} (Equation 1)
M^{(l)}=O√Λ̅√Λ̅O^{T}ΞS^{(l)}S^{(l)T}, (Equation 2)
wherein the S\hat{ }((l)) represents a pooling operator of the 1st layer,
the M^{(l)} represents a grouping matrix of the 1st layer,
the O represents O∈Rⁿ^{ₗ}^{×n}^{ₗ} in the orthogonal basis of the given matrix, and
the Λ represents Λ∈Rⁿ^{ₗ}^{×n}^{ₗ} as the eigen values.

5. The learning processing device of claim 1, wherein the pooling operator is in the form of a transformation matrix comprising a status of nodes for each group.

6. A method performed by the learning processing device, comprising:
generating a grouping matrix in a secondary form, grouped based on a similarity of pairwise nodes by inputting graph data into a pre-learned first artificial intelligence model; and
decomposing the grouping matrix to generate a pooling matrix,
wherein the grouping matrix is decomposed in a square-root form to obtain a pooling operator.

7. The learning processing method of claim 6, wherein generating the grouping matrix comprises grouping a plurality of nodes in the graph data and a connection relationship between the plurality of nodes by designating the plurality of nodes and the connection relationship as identifiers of 0 or more to 1 or less based on similarity according to a preset grouping criterion.

8. The learning processing method of claim 7, wherein obtaining the pooling operator comprises generating the pooling operator comprising a number of groups after pooling and the nodes assigned within the same group.

9. The learning processing method of claim 6, wherein the obtaining the pooling operator comprises generating the pooling operator based on equations (1) and (2) below:
S^{(l)}S^{(l)T}=M^{(l)} (Equation 1)
M^{(l)}=O√Λ̅√Λ̅O^{T}ΞS^{(l)}S^{(l)T}, (Equation 2)
wherein the S^{(l)} represents a pooling operator of the 1-th layer,
the M^{(l)} represents a grouping matrix of the 1-th layer,
the O represents O∈Rⁿ^{ₗ}^{×n}^{ₗ} in the orthogonal basis of the given matrix, and
the Λ represents Λ∈Rⁿ^{ₗ}^{×n}^{ₗ} as the eigen values.

10. The learning processing method of claim 6, wherein the pooling operator is in the form of a transformation matrix comprising a status of nodes for each group.

11. A program stored on a computer-readable recording medium, coupled with a computer, for executing the learning processing method of claim 6.

12. A method for learning an artificial intelligence model, performed by a learning processing device, comprising:
collecting graph data; and
learning an artificial intelligence model using the collected graph data;
wherein:
the learning the artificial intelligence model comprises:
generating a grouping matrix in a secondary form, grouped based on a similarity of pairwise nodes using the collected graph data; and
decomposing the grouping matrix to generate and output a pooling matrix; and the grouping matrix is decomposed in a square-root form to obtain a pooling operator.

13. The method for learning an artificial intelligence model of claim 12, wherein generating the grouping matrix comprises grouping a plurality of nodes in the graph data and a connection relationship between the plurality of nodes by designating the plurality of nodes and the connection relationship as identifiers of 0 or more to 1 or less based on similarity according to a preset grouping criterion.

14. The method for learning an artificial intelligence model of claim 13, wherein obtaining the pooling operator comprises generating the pooling operator comprising a number of groups after pooling and the nodes assigned within the same group.

15. The method for learning an artificial intelligence model of claim 12, wherein the obtaining the pooling operator comprises generating the pooling operator based on equations (1) and (2) below:
$${S}^{( l )} {S}^{( l ) T} = {M}^{( l )} \qquad ( Equation 1 )$$
$${M}^{( l )} = O \sqrt{Λ} \sqrt{Λ} {O}^{T} ≡ {S}^{( l )} {S}^{( l ) T} , \qquad ( Equation 2 )$$
wherein the S^{(l)} represents a pooling operator of the 1-th layer,
the M^{(l)} represents a grouping matrix of the 1-th layer,
the O represents O∈Rⁿ^{ₗ}^{×n}^{ₗ} in the orthogonal basis of the given matrix, and
the Λ represents Λ∈Rⁿ^{ₗ}^{×n}^{ₗ} as the eigen values.

16. The method for learning an artificial intelligence model of claim 12, wherein the pooling operator is in the form of a transformation matrix comprising a status of nodes for each group.
